(19) United States
(12) Patent Application Publication
(10) Pub. No.: US 2011/0127092 A1
(43) Pub. Date: Jun. 2, 2011

(54) POSITION APPARATUS FOR TOUCH DEVICE AND POSITION METHOD THEREFOR

(75) Inventor: Cheng-Long Lu, Miaoli County (TW)

(73) Assignee: ITE TECH. INC., Hsinchu (TW)

(21) Appl. No.: 12/700,698

(22) Filed: Feb. 4, 2010

(30) Foreign Application Priority Data
Nov. 27, 2009 (TW) 98140662

(51) Int. Cl. G06F 3/044

(52) U.S. Cl. 178/18.06

(57) ABSTRACT

A position method for a touch device is provided. In the position method, first, a controller is provided to set a boundary region on a touch panel of the touch device. When a touch medium touches the touch panel, the controller detects whether a peak capacitance detection differential value of a plurality of capacitance detection differential values is occurred in the boundary region. Besides, the controller performs an interpolation calculation to obtain a coordinate of a touch point for the touch medium according to the peak capacitance detection differential value and a first adjacent capacitance detection differential value which is adjacent to the peak capacitance detection differential value.

### CROSS-REFERENCE TO RELATED APPLICATION

This application claims the priority benefit of Taiwan application serial no. 98140662, filed on Nov. 27, 2009. The entirety of the above-mentioned patent application is hereby incorporated by reference herein and made a part of specification.

### BACKGROUND OF THE INVENTION

1. Field of the Invention

The invention relates to a position apparatus for a touch device and a position method therefor. More particularly, the invention relates to a position apparatus for positioning a touch point in a boundary region of a touch device and a position method therefor.

2. Description of Related Art

Along with advancement of technology, most electronic devices, such as notebook computers, cellular phones, or portable multimedia players, are usually equipped with touch panels as novel input interfaces. The touch panels can be categorized into resistant touch panels, capacitive touch panels, infrared ray touch panels, ultrasonic wave touch panels, and so on, among which the resistant touch panels and the capacitive touch panels are the most common products. When the capacitive touch panel is touched or approached by a finger or a conductive material, a capacitance change of the touch panel is induced. When the touch panel detects the capacitance change, the position where the finger or the conductive material touches or approaches is determined, and a function corresponding to the touched or approached position can then be performed.

According to the related art, a position of a touch point on the capacitive touch panel is determined from centroid calculation. See FIG. 1. FIG. 1 is a schematic view illustrating a capacitive touch panel 100 which is being touched. Here, the capacitive touch panel 100 includes detection units CIN8˜CIN15 detecting capacitance detection differential values at the vertical axis and detection units CIN0˜CIN7 detecting capacitance detection differential values at the horizontal axis. When a touch point P1 contacts the capacitive touch panel 100, distribution graphs 120 and 110 of the capacitance detection differential values are generated by the capacitive touch panel 100 at the vertical axis (the Y axis) and the horizontal axis (the X axis), respectively. At the Y axis, the touch point P1 mainly contacts a region detected by the detection unit CIN14. Therefore, a peak value is generated at a position where the distribution graph 120 of the capacitance detection differential value corresponds to the detection unit CIN14, while the capacitance detection differential values smaller than the peak value are transmitted by the detection units CIN13 and CIN15. The Y coordinate of the touch point P1 can be obtained by the centroid calculation according to the capacitance detection differential values transmitted by the detection units CIN13˜CIN15 and the corresponding coordinates.

The centroid calculation can be represented by the following equation:

$$POS = \frac{{C}_{i - 1} \times {P}_{i - 1} + {C}_{i} \times {P}_{i} + {C}_{i + 1} \times {P}_{i + 1}}{{C}_{i + 1} + {C}_{i} + {C}_{i + 1}}$$

Here, POS represents the detected coordinate of the touch point, and the peak value generated at the touch point corresponds to the detection unit CINᵢ. Cᵢ₋₁, Cᵢ, and Cᵢ₊₁ denote the capacitance detection differential values transmitted by the detection units CINᵢ₋₁, CINᵢ, and CINᵢ₊₁. Pᵢ₋₁, Pᵢ, and Pᵢ₊₁ denote the coordinates corresponding to the detection units CINᵢ₋₁, CINᵢ, and CINᵢ₊₁.

Nevertheless, when the touch point P1 contacts the right edge of the capacitive touch panel 100 as shown in FIG. 1, only two capacitance detection differential values transmitted by the detection units CIN6 and CIN7 can be obtained at the X axis. As such, it is not likely to calculate the X coordinate of the touch point P1 by way of the above-mentioned centroid calculation equation.

### SUMMARY OF THE INVENTION

The invention is directed to a position method for two kinds of touch devices respectively. By applying the position method, a touch point on an edge of a touch panel can be effectively positioned, and a coordinate of the touch point can then be obtained.

The invention is further directed to two kinds of touch devices for effectively positioning a touch point on an edge of a touch panel and calculating a coordinate of the touch point.

In the invention, a position method for a touch device is provided. According to the position method, first, a controller is provided to set a boundary region on a touch panel of the touch device. When a touch medium touches the touch panel, the controller detects whether a peak capacitance detection differential value of a plurality of capacitance detection differential values is occurred in the boundary region. Besides, the controller performs an interpolation calculation to obtain a coordinate of a touch point for the touch medium according to the peak capacitance detection differential value and a first adjacent capacitance detection differential value which is adjacent to the peak capacitance detection differential value.

According to an embodiment of the invention, the position method further includes providing the controller with the peak capacitance detection differential value and two second adjacent capacitance detection differential values adjacent to the peak capacitance detection differential value to perform a calculation to obtain the coordinate of the touch point when the peak capacitance detection differential value is not occurred in the boundary region.

According to an embodiment of the invention, the position method further includes detecting a set-up state of a dummy capacitance detection differential value with use of the controller and performing a calculation on the dummy capacitance detection differential value, the peak capacitance detection differential value, and the first adjacent capacitance detection differential value based on the set-up state to obtain the coordinate of the touch point.

According to an embodiment of the invention, the position method further includes detecting at least a first time point with use of the controller and obtaining a plurality of first capacitance detection differential values generated when the touch medium touches a non-boundary region on the touch panel. Next, the controller detects at a second time point and obtains a plurality of second capacitance detection differential values generated when the touch medium touches the boundary region on the touch panel. Finally, the controller is provided with the first capacitance detection differential values and the second capacitance detection differential values to calculate the dummy capacitance detection differential value.

According to an embodiment of the invention, the dummy capacitance detection differential value is equal to a difference between an average of a total value of the first capacitance detection differential values and a total value of the second capacitance detection differential values.

According to an embodiment of the invention, the dummy capacitance detection differential value is equal to a difference between a total value of the first capacitance detection differential values and a total value of the second capacitance detection differential values.

According to an embodiment of the invention, the touch medium moves in the non-boundary region on the touch panel at the at least a first time point.

According to an embodiment of the invention, the position method further includes providing a buffer memory to store the dummy capacitance detection differential value.

In the invention, another position method for a touch device is provided. According to the position method, first, a controller is provided to set a boundary region on a touch panel of the touch device, and the controller is provided with a dummy capacitance detection differential value. When a touch medium touches the touch panel, the controller detects whether a peak capacitance detection differential value of a plurality of capacitance detection differential values is occurred in the boundary region. A coordinate of a touch point is then calculated based on the dummy capacitance detection differential value, the peak capacitance detection differential value, and an adjacent capacitance detection differential value adjacent to the peak capacitance detection differential value.

In the invention, a touch device including a touch panel and a controller is further provided. The controller is coupled to the touch panel for setting a boundary region on the touch panel of the touch device. When a touch medium touches the touch panel, the controller detects whether a peak capacitance detection differential value of a plurality of capacitance detection differential values is occurred in the boundary region. Besides, the controller performs an interpolation calculation to obtain a coordinate of a touch point for the touch medium according to the peak capacitance detection differential value and a first adjacent capacitance detection differential value which is adjacent to the peak capacitance detection differential value.

In the invention, another touch device including a touch panel and a controller is provided. The controller is coupled to the touch panel and receives a dummy capacitance detection differential value. The controller is used for setting a boundary region on the touch panel of the touch device. When a touch medium touches the touch panel, the controller detects whether a peak capacitance detection differential value of a plurality of capacitance detection differential values is occurred in the boundary region. The controller also calculates a coordinate of a touch point based on the dummy capacitance detection differential value, the peak capacitance detection differential value, and an adjacent capacitance detection differential value adjacent to the peak capacitance detection differential value.

Based on the above, the dummy capacitance detection differential value is generated in the invention to supplement the lack of the capacitance detection differential value when the touch medium touches the boundary region on the touch panel, so as to calculate the coordinate of the touch point. In addition, when the dummy capacitance detection differential value is not effectively generated yet, an interpolation calculation is performed on the peak capacitance detection differential value and the adjacent capacitance detection differential value generated when the touch medium touches the boundary region on the touch panel, so as to obtain the coordinate of the touch point for the touch medium.

It is to be understood that both the foregoing general descriptions and the following detailed embodiments are exemplary and are, together with the accompanying drawings, intended to provide further explanation of technical features and advantages of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a capacitive touch panel 100 which is being touched.

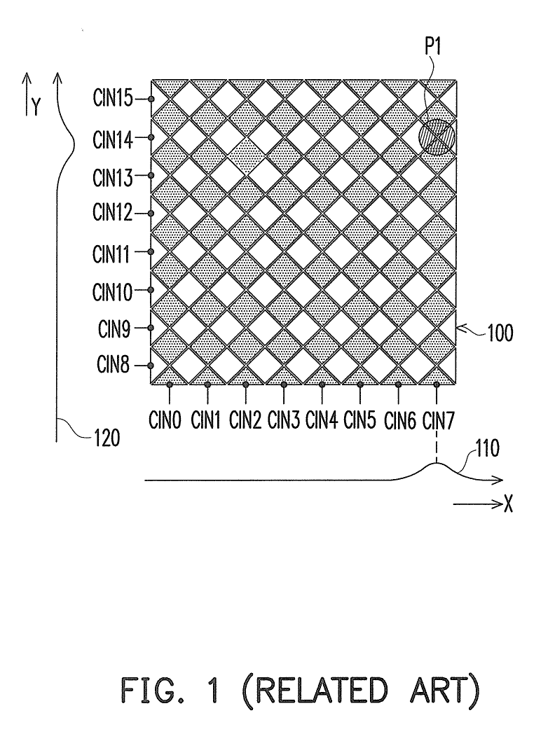

FIG. 2A is a flowchart illustrating a position method for a touch device according to an embodiment of the invention.

FIG. 2B is a schematic view illustrating a touch device 200 which is being touched according to the embodiment depicted in FIG. 2A.

FIG. 3A is a flowchart illustrating a position method for a touch device according to another embodiment of the invention.

FIG. 3B is a schematic view illustrating a touch panel 310 of a touch device 300 according to the embodiment depicted in FIG. 3A.

FIG. 4 is a flowchart illustrating a position method for a touch device according to still another embodiment of the invention.

FIG. 5 is a schematic view illustrating a touch device 500 according to an embodiment of the invention.

### DESCRIPTION OF EMBODIMENTS

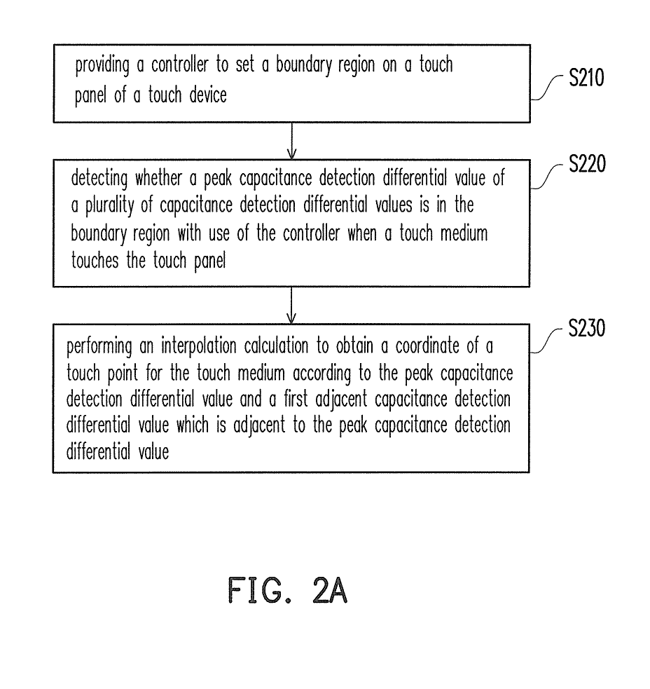

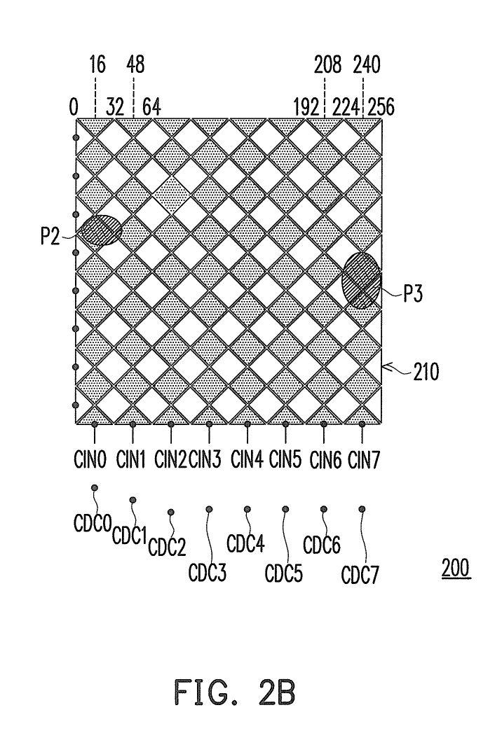

See FIG. 2A. FIG. 2A is a flowchart illustrating a position method for a touch device according to an embodiment of the invention. According to the position method, first, a controller is provided to set a boundary region on a touch panel of the touch device (step S210). The boundary region herein refers to a region where the touch device can merely transmit two effective capacitance detection differential values when a touch point contacts the touch panel. See FIGS. 2A and 2B. FIG. 2B is a schematic view illustrating a touch device 200 which is being touched according to the embodiment depicted in FIG. 2A. In FIG. 2B, the touch device 200 includes a touch panel 210 and detection units CIN0˜CIN7 at the horizontal axis. The detection units CIN0˜CIN7 detect and transmit the capacitance detection differential values at the horizontal axis when the touch point is on the touch panel 210.

When a touch medium touches the touch panel 210, the controller detects the maximum value of a plurality of capacitance detection differential values CDC0˜CDC7. Namely, the controller detects whether a peak capacitance detection differential value is occurred in the boundary region (step S220). In FIG. 2B, a touch point P2 touches a left region of the touch panel 210, and the detection units CIN0˜CIN7 correspondingly transmit the capacitance detection differential values CDC0˜CDC7. Here, the touch point P2 is relatively close to the detection unit CIN0, and therefore the capacitance detection differential value CDC0 transmitted by the detection unit CIN0 is the greatest (the peak) capacitance detection differential value of the capacitance detection differential values CDC0˜CDC7.

As discussed above, when the touch point P2 touches the boundary region on the touch panel 210, the touch device 200 can merely transmit two effective capacitance detection differential values. In this embodiment, these two effective capacitance detection differential values refer to the peak capacitance detection differential value CDC0 transmitted by the detection unit CIN0 and the capacitance detection differential value CDC1 transmitted by the detection unit CIN1.

Practically, due to noise or other factors, note that the capacitance detection differential value transmitted by the detection unit may not be 0 when the touch panel 210 is not touched. Hence, in order to make sure the capacitance detection differential values transmitted by the detection units are the effective capacitance detection differential values, whether the capacitance detection differential values are greater than a threshold value is frequently determined. In brief, if the capacitance detection differential values transmitted by the detection units are greater than the threshold value, the capacitance detection differential values are deemed effective.

See FIGS. 2A and 2B. In step S220, whether the peak capacitance detection differential value is occurred in the boundary region is determined, which means the coordinate of the touch point cannot be positioned in the manner of the conventional three-point centroid calculation. Accordingly, an interpolation calculation is performed to obtain the coordinate of the touch point for the touch medium according to the peak capacitance detection differential value and an adjacent capacitance detection differential value which is adjacent to the peak capacitance detection differential value. In FIG. 2B, the touch point P2 contacts the touch panel 210, such that the detection unit CIN0 generates the peak capacitance detection differential value CDC0, and that the detection unit CIN1 generates the adjacent capacitance detection differential value CDC1. Here, the coordinate of the touch point P2 at the horizontal axis can be obtained by performing an interpolation calculation on the peak capacitance detection differential value CDC0 and the adjacent capacitance detection differential value CDC1. The calculation is shown in the following equation (1):

$$X = \frac{CDC 0 \times 0 + CDC 1 \times 64}{CDC 0 + CDC 1} \qquad ( 1 )$$

Here, when a width of a scan line is set as 32, for example, the detection unit CIN0 correlates with a touch condition on which a horizontal coordinate of the touch panel 210 is 0, and the detection unit CIN1 correlates with a touch condition on which the horizontal coordinate of the touch panel 210 is 64, i.e. 64 (twice the width of the scan line) is added.

On the other hand, another touch point P3 is taken for instance. When the touch point P3 appears at a right region of the touch panel 210, the detection unit CIN7 yields a peak capacitance detection differential value CDC7, and the detection unit CIN6 yields the adjacent capacitance detection differential value CDC6. The calculation made on the coordinate of the touch point P3 at the horizontal axis is shown in the following equation (2):

$$X = \frac{CDC 6 \times 192 + CDC 7 \times 256}{CDC 6 + CDC 7} \qquad ( 2 )$$

In this equation, the detection unit CIN7 correlates with a touch condition on which a horizontal coordinate is 256, and the detection unit CIN6 correlates with a touch condition on which the horizontal coordinate is 192, i.e. 64 (twice the width of the scan line) is subtracted from 256.

Note that the above descriptions are provided on the circumstances that the touch points P2 and P3 are positioned at the horizontal axis. As a matter of fact, the position method of the touch points P2 and P3 at the vertical axis is the same as the position method of the touch points P2 and P3 at the horizontal axis. The difference therebetween lies in that the capacitance detection differential values transmitted by the detection units at the vertical axis are used in the position method of the touch points P2 and P3 at the vertical axis. The details of the position method of the touch points P2 and P3 at the vertical axis are similar to those at the horizontal axis, and therefore no further description is provided herein.

In view of the above, it can be learned that when the touch medium touches the boundary region on the touch panel, the horizontal coordinate of the touch point can be calculated by the above equation (1) or (2), which is determined by the touch medium touching the left boundary region or the right boundary region. As such, the issue of positioning the touch point occurred in the boundary region can be resolved.

Certainly, given that the touch point is not occurred in the boundary region on the touch panel, the coordinate of the touch point can be positioned in the manner of the conventional centroid calculation.

It should be mentioned that the above-referenced touch medium can be a stylus or a finger which allows the capacitive touch panel to yield the capacitance detection differential value, for example. Besides, the aforesaid controller refers to a circuit which is installed in the touch device 200 and is capable of computing, e.g. a microprocessor.

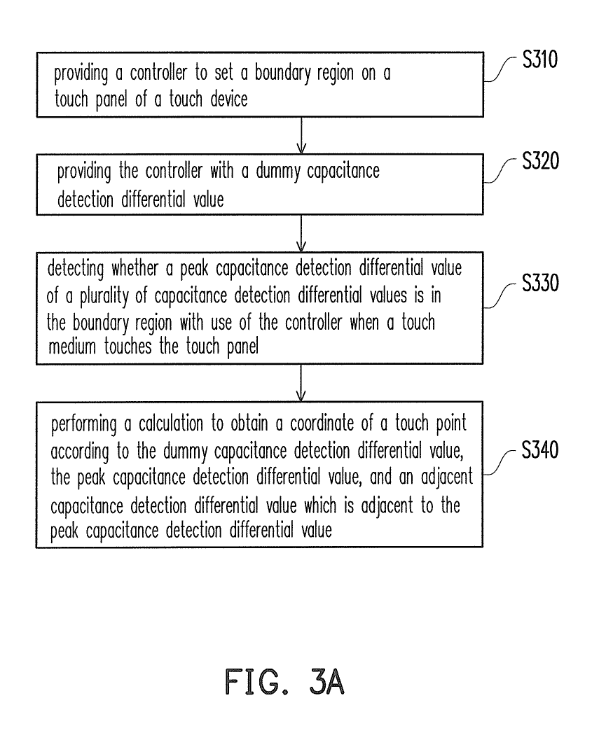

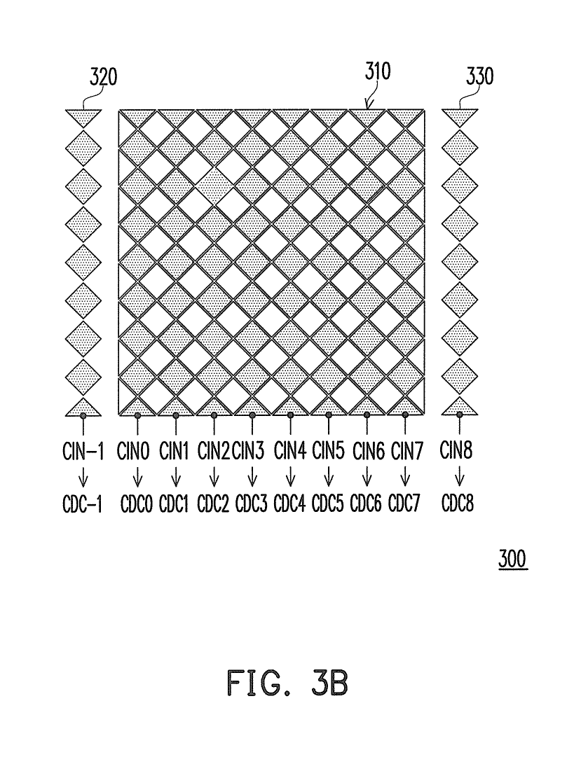

See FIG. 3A. FIG. 3A is a flowchart illustrating a position method for a touch device according to another embodiment of the invention. In this embodiment, first, a controller is provided to set a boundary region on a touch panel of the touch device (step S310), and the controller receives a dummy capacitance detection differential value (step S320). See FIGS. 3A and 3B. FIG. 3B is a schematic view illustrating a touch panel 310 of a touch device 300 according to the embodiment depicted in FIG. 3A. In FIG. 3B, the touch device 300 not only includes a physical touch panel 310 but also includes dummy scan lines 320 and 330 respectively at the left side and the right side of the touch panel 310. According to this embodiment, the dummy scan lines 320 and 330 correspondingly transmit the dummy capacitance detection differential values when the touch medium touches the boundary region on the touch panel 310. Here, when the touch medium touches the left boundary region of the touch panel 310, the dummy scan line 320 transmits the dummy capacitance detection differential value CDC−1. On the contrary, when the touch medium touches the right boundary region of the touch panel 310, the dummy scan line 330 transmits the dummy capacitance detection differential value CDC8. Accordingly, when the dummy scan lines are available, the dummy capacitance detection differential values can be provided, and the conventional centroid calculation can be performed to position the coordinate of the touch point.

The dummy capacitance detection differential values CDC−1 and CDC8 can be stored in a memory (not shown) and read by the controller in step S320 of this embodiment. The dummy capacitance detection differential values CDC−1 and CDC8 are either the fixed values or the values that can be dynamically updated at all times. Calculations on the dummy capacitance detection differential values CDC−1and CDC8 will be described later, given the dummy capacitance detection differential values CDC−1 and CDC8 are dynamically updated at all times.

See FIGS. 3A and 3B. After the controller receives the dummy capacitance detection differential values, and when the touch medium touches the touch panel 310, the controller detects whether a peak capacitance detection differential value of a plurality of capacitance detection differential values is occurred in the boundary region (step S330). That is to say, the controller detects whether the touch point is occurred in the boundary region on the touch panel 310, and then a proper way to calculate the coordinate is determined based on the detection result.

Once the touch point is found occurred in the boundary region on the touch panel 310, the controller calculates the coordinate of the touch point based on the dummy capacitance detection differential value, the peak capacitance detection differential value, and an adjacent capacitance detection differential value adjacent to the peak capacitance detection differential value (step S330). As a matter of course, note that only two capacitance detection differential values are transmitted by the touch device 300 when the touch medium touches the boundary region on the touch panel 310. However, the coordinate of the touch point can be calculated by way of the conventional three-point centroid calculation if the dummy capacitance detection differential value is available in addition to the two capacitance detection differential values generated on the physical touch panel 310.

The way to obtain the dummy capacitance detection differential value is described in the following embodiment, such that people having ordinary skill in the art can better understand the invention.

First, at least a first time point, the controller detects and obtains a plurality of first capacitance detection differential values generated when the touch medium touches a non-boundary region on the touch panel 310. Next, at a second time point different from the first time point, the controller detects and obtains a plurality of second capacitance detection differential values generated when the touch medium touches the boundary region on the touch panel 310. Finally, the dummy capacitance detection differential value is the difference between an average of the sum of the first capacitance detection differential values and the sum of the second capacitance detection differential values. In an alternative, the dummy capacitance detection differential value can also be the difference between the sum of the first capacitance detection differential values and the sum of the second capacitance detection differential values.

At the first time point, note that the touch medium can move in regions correspondingly detected by the detection units CIN1˜CIN6 or stay in a region correspondingly detected by the same detection unit, e.g. the detection unit CIN1 or CINE.

For instance, at the first time point t1, the touch medium touches the non-boundary region on the touch panel 310, and the capacitance detection differential values CDCOₜ₁, CDC1ₜ₁, and CDC2ₜ₁ are obtained. At the second time point t2, the touch medium touches the boundary region on the touch panel 310, and two capacitance detection differential values CDC0ₜ₂ and CDC1ₜ₂ are obtained. As such, the dummy capacitance detection differential value CDC−1 can be obtained by the following equation (3):

CDC−1ₜ₂=(CDC0ₜ₁+CDC1ₜ₁+CDC2ₜ₁)−(CDC0ₜ₂+CDC1ₜ₂) (3)

Furthermore, the dummy capacitance detection differential value CDC−1 can also be obtained with the equation listed below. Namely, at the time points between the values of t1 and tn−1, when the peak capacitance detection differential values are all found in the detection units CIN1˜CIN6, the sum of the three capacitance detection differential values derived from each time point is calculated to obtain the average. The sum of two capacitance detection differential values is generated when the peak capacitance detection differential value is occurred in the boundary region at the time point tn. The dummy capacitance detection differential value CDC−1 can be obtained by subtracting the sum of the two capacitance detection differential values from the aforesaid average. The equation (4) representing the above calculation can be found below:

CDC−1ₜₙ=[(CDC2ₜ₁+CDC3ₜ₁+CDC4ₜ₁)+(CDC1ₜ₂+CDC2ₜ₂+CDC3ₜ₂)+(CDC0ₜₙ₋₁+CDC1ₜₙ₋₁+CDC2ₜₙ₋₁)]/(n−1)−(CDC0ₜₙ+CDC1ₜₙ) (4)

In the equation (4), at the time point t1, the peak capacitance detection differential value is found in the detection unit CIN3; at the time point t2, the peak capacitance detection differential value is found in the detection unit CIN2; at the time point tn−1, the peak capacitance detection differential value is found in the detection unit CIN1.

Note that the correlations between the time points and the peak capacitance detection differential values transmitted by the detection units are merely exemplary, while the equation (4) is subject to dynamic change when different time points and different peak capacitance detection differential values transmitted by the detection units are given.

Certainly, at the time point tn+1 or at any time point after the time point tn, if the peak capacitance detection differential value is occurred in the boundary region, the equation (4) is applicable. Namely, the dummy capacitance detection differential value can be obtained by subtracting the sum of the two capacitance detection differential values from the average of the sum of the three capacitance detection differential values derived from each time point (t1˜tn−1). Note that the sum of the two capacitance detection differential values is generated when the peak capacitance detection differential value is occurred in the boundary region.

Furthermore, the dummy capacitance detection differential value CDC−1 can also be obtained with the equation listed below. In other words, at the time points between the values of t1 and tn−1, the dummy capacitance detection differential value CDC−1 can also be obtained by subtracting the sum of the two capacitance detection differential values generated when the peak capacitance detection differential value is occurred in the boundary region at the time point tn from the average of the sum of the capacitance detection differential values generated by the detection units CIN0˜CIN2, for example.

The equation (5) representing the above calculation can be found below:

CDC−1ₜₙ=[(CDC0ₜ₁+CDC1ₜ₁+CDC2ₜ₁)+(CDC0ₜ₂+CDC1ₜ₂+CDC2ₜ₂)+(CDC0ₜₙ₋₁+CDC1ₜ₋₁+CDC2ₜₙ₋₁)]/(n−1)−(CDC0ₜₙ+CDC1ₜₙ) (5)

The equations (3)˜(5) representing the calculation methods and the results are described by the following example. Please refer to Table 1 indicated below. In Table 1, the correlations between the capacitance detection differential values CDC0˜CDC7 transmitted by the detection units CIN0˜CIN7 at the time points t0˜t6 are listed.

TABLE 1

| | CDC0 | CDC1 | CDC2 | CDC3 | CDC4 | CDC5 | CDC6 | CDC7 |
|---|---|---|---|---|---|---|---|---|
| t0 | 0 | 0 | 0 | 0 | 0 | 0 | 0 | 0 |
| t1 | 0 | 0 | 150 | 200 | 100 | 0 | 0 | 0 |
| t2 | 0 | 140 | 220 | 80 | 0 | 0 | 0 | 0 |
| t3 | 80 | 210 | 130 | 0 | 0 | 0 | 0 | 0 |
| t4 | 130 | 200 | 90 | 0 | 0 | 0 | 0 | 0 |
| t5 | 210 | 150 | 0 | 0 | 0 | 0 | 0 | 0 |
| t6 | 220 | 100 | 0 | 0 | 0 | 0 | 0 | 0 |

As shown in Table 1, at the time point t0, the finger does not touch the touch panel, and all of the capacitance detection differential values CDC0˜CDC7 are equal to 0. At the time point t1, the finger touches regions detected by the detection units CIN2˜CIN4 and moves toward the region detected by the detection unit CIN0 when the time increases (at the time points t2˜t6).

As exemplarily shown in the equation (3), the dummy capacitance detection differential value at the time point t5 is represented below.

CDC−1ₜ₅=(130+200+90)−(210+150)

The dummy capacitance detection differential value at the time point t6 is represented below.

CDC−1ₜ₆=(130+200+90)−(220+100)

As exemplarily shown in the equation (4), the dummy capacitance detection differential value at the time point t5 is represented below.

CDC−1ₜ₅=(SumA/4)−(210+150)

The dummy capacitance detection differential value at the time point t6 is represented below.

CDC−1ₜ₆=(SumA/4)−(220+100),

wherein

SumA=[(150+200+100)+(140+220+80)+(80+210+130)+(130+200+90)].

As exemplarily shown in the equation (5), the dummy capacitance detection differential value at the time point t5 is represented below.

CDC−1ₜ₅=(SumB/2)−(210+150)

The dummy capacitance detection differential value at the time point t6 is represented below.

CDC−1ₜ₆=(SumB/2)−(220+100),

wherein

SumB=[(80+210+130)+(130+200+90)].

Note that the detection units CIN−1 and CIN8 are dummy detection units. Hence, if the coordinate of the touch point which is calculated according to the dummy capacitance detection differential value is in the region correspondingly detected by the detection units CIN−1 and CIN8, the touch point is ineffective. At this time, the coordinate of the touch point can be neglected, or the coordinate on the edge serves as the coordinate of the touch point which is positioned.

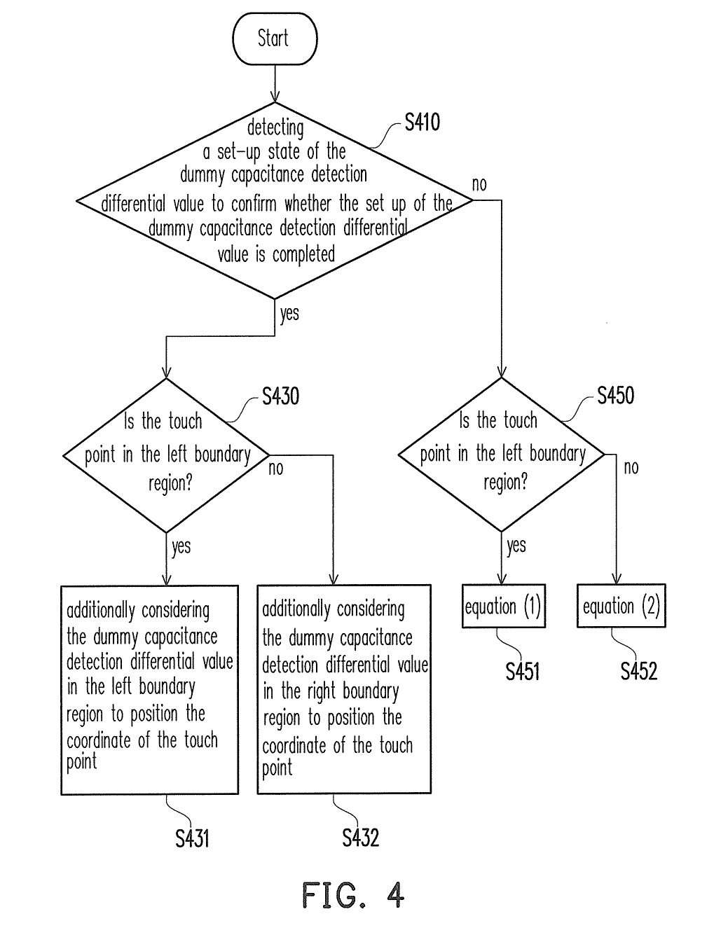

See FIG. 4. FIG. 4 is a flowchart illustrating a position method for a touch device according to still another embodiment of the invention. In the position method, a set-up state of the dummy capacitance detection differential value is detected. This is to confirm whether the set up of the dummy capacitance detection differential value is completed (step S410). Upon completion of the set up, it can be determined whether the information for obtaining the dummy capacitance detection differential value by means of the equations (3)-(5) discussed in the above example is sufficient. If the dummy capacitance detection differential value is successfully set up, then whether the touch point is in the left boundary region on the touch panel is determined (step S430). If the touch point is found in the left region on the touch panel, then the coordinate of the touch point can be positioned by additionally considering the dummy capacitance detection differential value in the left boundary region (step S431). Conversely, if the touch point is found in the right boundary region of the touch panel, then the coordinate of the touch point can be positioned by additionally considering the dummy capacitance detection differential value in the right boundary region (step S432).

On the other hand, in step S410, if the incompletion of the set up of the dummy capacitance detection differential value is detected, then whether the touch point is in the left boundary region on the touch panel is determined (step S450). If the touch point is found in the left boundary region on the touch panel, the equation (1) is applied to calculate the coordinate of the touch point (step S451). Conversely, if the touch point is found in the right boundary region on the touch panel, the equation (2) is applied to calculate the coordinate of the touch point (step S452).

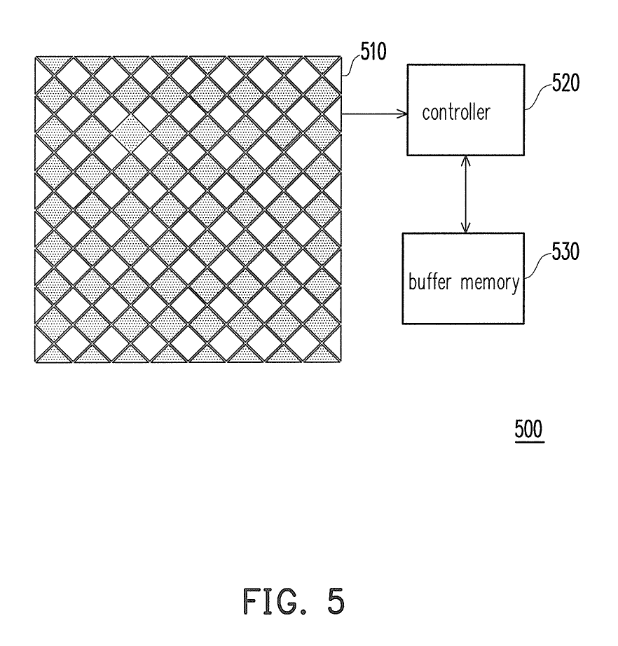

See FIG. 5. FIG. 5 is a schematic view illustrating a touch device 500 according to an embodiment of the invention. The touch device 500 includes a touch panel 510, a controller 520, and a buffer memory 530. The controller 520 is coupled to the touch panel 510. The controller 520 is used to set a boundary region on the touch panel 510. Besides, the controller 520 detects whether a peak capacitance detection differential value of a plurality of capacitance detection differential values is occurred in the boundary region when a touch medium touches the touch panel 510. Moreover, the controller 520 performs a calculation to obtain a coordinate of a touch point according to the peak capacitance detection differential value and an adjacent capacitance detection differential value adjacent to the peak capacitance detection differential value, or according to a dummy capacitance detection differential value, the peak capacitance detection differential value, and the adjacent capacitance detection differential value adjacent to the peak capacitance detection differential value. Here, how the controller 520 positions the coordinate of the touch point is the same as the position method described above, and therefore no further description is provided herein.

The buffer memory 530 is coupled to the controller 520, such that the controller 520 is allowed to access the dummy capacitance detection differential value.

In conclusion, this invention utilizes the dummy capacitance detection differential value to supplement the lack of the capacitance detection differential value when the touch point is occurred in the boundary region. With the conventional three-point centroid calculation, the coordinate of the touch point occurred in the boundary region can be effectively calculated. In addition, the interpolation calculation can be performed on the peak capacitance detection differential value and the adjacent capacitance detection differential value, so as to position the coordinate of the touch point occurred in the boundary region when the dummy capacitance detection differential value is not effectively generated. Thereby, all the touch points on the touch device can be effectively positioned under all circumstances.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A position method for a touch device, the position method comprising:
providing a controller to set a boundary region on a touch panel of the touch device;
providing the controller for detecting whether a peak capacitance detection differential value of a plurality of capacitance detection differential values is occurred in the boundary region when a touch medium touches the touch panel; and
providing the controller with the peak capacitance detection differential value and a first adjacent capacitance detection differential value adjacent to the peak capacitance detection differential value to perform an interpolation calculation to obtain a coordinate of a touch point for the touch medium.

2. The position method as claimed in claim 1, further comprising:
providing the controller with the peak capacitance detection differential value and two second adjacent capacitance detection differential values adjacent to the peak capacitance detection differential value to perform a calculation to obtain the coordinate of the touch point when the peak capacitance detection differential value is not occurred in the boundary region.

3. The position method as claimed in claim 1, further comprising:
detecting a set-up state of a dummy capacitance detection differential value with use of the controller; and
performing a calculation on the dummy capacitance detection differential value, the peak capacitance detection differential value, and the first adjacent capacitance detection differential value based on the set-up state to obtain the coordinate of the touch point.

4. The position method as claimed in claim 3, further comprising:
providing the controller for detecting and obtaining a plurality of first capacitance detection differential values generated when the touch medium touches a non-boundary region on the touch panel at least a first time point;
detecting at a second time point with use of the controller and obtaining a plurality of second capacitance detection differential values generated when the touch medium touches the boundary region on the touch panel; and
providing the controller with the plurality of first capacitance detection differential values and the plurality of second capacitance detection differential values to calculate the dummy capacitance detection differential value.

5. The position method as claimed in claim 4, wherein the dummy capacitance detection differential value is equal to a difference between an average of a total value of the plurality of first capacitance detection differential values and a total value of the plurality of second capacitance detection differential values.

6. The position method as claimed in claim 4, wherein the dummy capacitance detection differential value is equal to a difference between a total value of the plurality of first capacitance detection differential values and a total value of the plurality of second capacitance detection differential values.

7. The position method as claimed in claim 4, wherein the touch medium moves in the non-boundary region on the touch panel at the at least a first time point.

8. The position method as claimed in claim 3, further comprising:
providing a buffer memory to store the dummy capacitance detection differential value.

9. A position method for a touch device, the position method comprising:
providing a controller to set a boundary region on a touch panel of the touch device;
providing the controller with a dummy capacitance detection differential value;
providing a controller for detecting whether a peak capacitance detection differential value of a plurality of capacitance detection differential values is occurred in the boundary region when a touch medium touches the touch panel; and
calculating a coordinate of a touch point based on the dummy capacitance detection differential value, the peak capacitance detection differential value, and an adjacent capacitance detection differential value adjacent to the peak capacitance detection differential value.

10. The position method as claimed in claim 9, further comprising:
providing the controller for detecting and obtaining a plurality of first capacitance detection differential values generated when the touch medium touches a non-boundary region on the touch panel at least a first time point;
detecting at a second time point with use of the controller and obtaining a plurality of second capacitance detection differential values generated when the touch medium touches the boundary region on the touch panel; and
providing the controller with the plurality of first capacitance detection differential values and the plurality of second capacitance detection differential values to calculate the dummy capacitance detection differential value.

11. The position method as claimed in claim 10, wherein the dummy capacitance detection differential value is equal to a difference between an average of a total value of the plurality of first capacitance detection differential values and a total value of the plurality of second capacitance detection differential values.

12. The position method as claimed in claim 10, wherein the dummy capacitance detection differential value is equal to a difference between a total value of the plurality of first capacitance detection differential values and a total value of the plurality of second capacitance detection differential values.

13. The position method as claimed in claim 10, wherein the touch medium moves in the non-boundary region on the touch panel at the at least a first time point.

14. The position method as claimed in claim 10, wherein at the at least a first time point, the touch medium moves in a region correspondingly detected by a detection unit, and the region is next to the boundary region.

15. The position method as claimed in claim 9, further comprising:
providing a buffer memory to store the dummy capacitance detection differential value.

16. A touch device comprising:
a touch panel; and
a controller coupled to the touch panel for setting a boundary region on the touch panel, the controller detecting whether a peak capacitance detection differential value of a plurality of capacitance detection differential values is occurred in the boundary region when a touch medium touches the touch panel, the controller performing an interpolation calculation to obtain a coordinate of a touch point for the touch medium according to the peak capacitance detection differential value and a first adjacent capacitance detection differential value adjacent to the peak capacitance detection differential value.

17. The touch device as claimed in claim 16, wherein the controller is further provided with the peak capacitance detection differential value and two second adjacent capacitance detection differential values adjacent to the peak capacitance detection differential value to perform a calculation to obtain the coordinate of the touch point when the peak capacitance detection differential value is not occurred in the boundary region.

18. The touch device as claimed in claim 16, wherein the controller detects a set-up state of a dummy capacitance detection differential value and performs a calculation on the dummy capacitance detection differential value, the peak capacitance detection differential value, and the first adjacent capacitance detection differential value based on the set-up state to obtain the coordinate of the touch point.

19. The touch device as claimed in claim 18, wherein the controller further detects at least a first time point and obtains a plurality of first capacitance detection differential values generated when the touch medium touches a non-boundary region on the touch panel, detects at a second time point and obtains a plurality of second capacitance detection differential values generated when the touch medium touches the boundary region on the touch panel, and calculates the dummy capacitance detection differential value based on the plurality of first capacitance detection differential values and the plurality of second capacitance detection differential values.

20. The touch device as claimed in claim 19, wherein the dummy capacitance detection differential value is equal to a difference between an average of a total value of the plurality of first capacitance detection differential values and a total value of the plurality of second capacitance detection differential values.

21. The touch device as claimed in claim 19, wherein the dummy capacitance detection differential value is equal to a difference between a total value of the plurality of first capacitance detection differential values and a total value of the plurality of second capacitance detection differential values.

22. The touch device as claimed in claim 19, wherein the touch medium moves in the non-boundary region on the touch panel at the at least a first time point.

23. The touch device as claimed in claim 19, wherein at the at least a first time point, the touch medium moves in a region correspondingly detected by a detection unit, and the region is next to the boundary region.

24. The touch device as claimed in claim 18, further comprising:
a buffer memory coupled to the controller for storing the dummy capacitance detection differential value.

25. A touch device comprising:
a touch panel; and
a controller coupled to the touch panel and receiving a dummy capacitance detection differential value for setting a boundary region on the touch panel of the touch device, the controller detecting whether a peak capacitance detection differential value of a plurality of capacitance detection differential values is occurred in the boundary region when a touch medium touches the touch panel, the controller performing a calculation to obtain a coordinate of a touch point according to the dummy capacitance detection differential value, the peak capacitance detection differential value, and an adjacent capacitance detection differential value adjacent to the peak capacitance detection differential value.

26. The touch device as claimed in claim 25, wherein the controller further detects at least a first time point and obtains a plurality of first capacitance detection differential values generated when the touch medium touches a non-boundary region on the touch panel, detects at a second time point and obtains a plurality of second capacitance detection differential values generated when the touch medium touches the boundary region on the touch panel, and calculates the dummy capacitance detection differential value based on the plurality of first capacitance detection differential values and the plurality of second capacitance detection differential values.

27. The touch device as claimed in claim 26, wherein the dummy capacitance detection differential value is equal to a difference between an average of a total value of the plurality of first capacitance detection differential values and a total value of the plurality of second capacitance detection differential values.

28. The touch device as claimed in claim 26, wherein the dummy capacitance detection differential value is equal to a difference between a total value of the plurality of first capacitance detection differential values and a total value of the plurality of second capacitance detection differential values.

29. The touch device as claimed in claim 26, wherein the touch medium moves in the non-boundary region on the touch panel at the at least a first time point.

30. The touch device as claimed in claim 26, wherein at the at least a first time point, the touch medium moves in a region correspondingly detected by a detection unit, and the region is next to the boundary region.

31. The touch device as claimed in claim 25, further comprising:
a buffer memory coupled to the controller for storing the dummy capacitance detection differential value.
